(19) United States
(12) Patent Application Publication
(10) Pub. No.: US 2007/0114693 A1
(43) Pub. Date: May 24, 2007

(54) Methods for improving mold quality for use in the manufacture of liquid crystal display components

(76) Inventors: Paul William Buckley, Scotia, NY (US); Kevin Patrick Capaldo, Mount Vernon, IN (US); Jamuna Chakravarti, Evansville, IN (US); Mark Allen Cheverton, Mechanicville, NY (US); David Dean Clinnin, Newburgh, IN (US); Michael John Davis, Mount Vernon, IN (US); Robert Douglas Little, Mount Vernon, IN (US); Vijay Krishna Paruchuru, Latham, NY (US); Micah Sakiestewa Sze, Albany, NY (US); Sameer Kirti Talsania, Evansville, IN (US); Vicki Herzl Watkins, Alplaus, NY (US); Masako Yamada, Niskayuna, NY (US); Jana Sue York, Mount Vernon, IN (US); Kenneth Paul Zarnoch, Scotia, NY (US)

Correspondence Address: CANTOR COLBURN, LLP, 55 GRIFFIN ROAD SOUTH, BLOOMFIELD, CT, 06002, US

(21) Appl. No.: 11/285,137

(22) Filed: Nov. 21, 2005

(51) Int. Cl. B29C 73/00; B29C 45/76

(52) U.S. Cl. 264/40.1; 425/173; 264/36.1

(57) ABSTRACT

Disclosed herein is a method comprising inspecting a mold for a defect; determining a type of defect present on the mold; sorting the mold by type of defect present; treating the mold with a cleaning process that is suitable to remove the defect; and pressing the mold against a polymeric film to produce a series of defect free light management films; wherein the yield of light management films manufactured from the mold is higher than the yield of light management films that are produced from a comparative mold that has not been treated with the cleaning process.

### BACKGROUND

This disclosure relates to methods for improving mold yields for use in the manufacture of flat panel light management films.

Molds such as, for example, electroforms are generally used for manufacturing light management films such as prism sheets for use in liquid crystalline displays. In general, such light management films have at least one microstructured surface that refracts light in a manner effective to enhance the light output of the display. Since these films serve an optical function, it is desirable for the surface features to be of high quality with no roughness or other defects. The microstuctures on the light management films is first generated on a master, which may be a silicon wafer, glass plate, metal drum, or the like; and is created by one of a variety of processes such as photolithography, etching, ruling, diamond turning, or other processes. Since this master tends to be expensive to produce and fragile in nature, tooling or molds are generally reproduced off of this master, which in turn serve as the molds from which the light management films are mass-produced. These molds can be metal copies grown via electroforming processes, or plastic copies formed via molding-type processes.

Molds copied directly from the master (also called a parent mold) are called first generation molds (also called daughter molds), copies of these first generation molds are called second generation molds, and so on. In general, multiple copies can be made of every mold made at any generation, leading to a geometric growth in number of molds with each generation—i.e., a “tooling tree” is produced. Each generation is an inverted image of the previous generation. If the desired final product is a “positive” geometry, then any generation of tooling that is a negative can be used as a mass-production replication mold. If the master is manufactured as a negative, then any even-generation mold can be used for mass-production, and vice-versa.

Any mold can have a defect that developed during its manufacture. If the defect persists in a parent mold, then that defect can be propagated to all subsequent generations of daughter molds and films. In addition, new defects can appear during the formation of each new generation of a mold, and the defect can subsequently be propagated to the future generations if left undetected and uncorrected. Any defect in a mold will propagate to every copy of that mold, and all subsequent generations of molds. Any defect in a mold used for mass-production of light management films will be replicated in every film produced, resulting in 100% rejection of the films.

There is therefore a need for a process that detects such defects and corrects molds in order to minimize propagating defects to further generations of molds and light management films, thus improving their yield. Furthermore, it is desirable for the defect correction procedure to preserve the optical surfaces of the microstructure, and not introduce any defects such as roughness, pitting, staining, and the like.

### SUMMARY

Disclosed herein is a method comprising inspecting a mold for a defect; determining a type of defect present on the mold; and treating the mold with a cleaning process comprising one or more cycles that is suitable to remove the defect; wherein the mold does not undergo a degradation in cosmetic quality or luminance as a result of being subjected to the cleaning process.

Disclosed herein is a method comprising inspecting a mold for a defect; determining a type of defect present on the mold; sorting the mold by type of defect present; and treating the mold with a cleaning process that is suitable to remove the defect without damaging the mold.

Disclosed herein is a method comprising inspecting a mold for a defect; determining a type of defect present on the mold; sorting the mold by type of defect present; treating the mold with a cleaning process that is suitable to remove the defect; and pressing the mold against a polymeric film to produce a series of defect free light management films; wherein the yield of light management films manufactured from the mold is higher than the yield of light management films that are produced from a comparative mold that has not been treated with the cleaning process.

Disclosed herein too is a method comprising treating a mold with a cleaning process to from a clean mold; wherein the cleaning process comprises subjecting the electroform to soaking, electrocleaning, a water jet pressurized to at least 15 pounds per square inch, ultrasonication, or a combination comprising at least one of the foregoing cleaning processes; and electroforming a mold using the clean mold as a template.

### DETAILED DESCRIPTION OF FIGURES

FIG. 1, represents a photograph of a defect (prior to ultrasonication), showing a horizontal white line stain (indicated by arrow) in the middle of the circle;

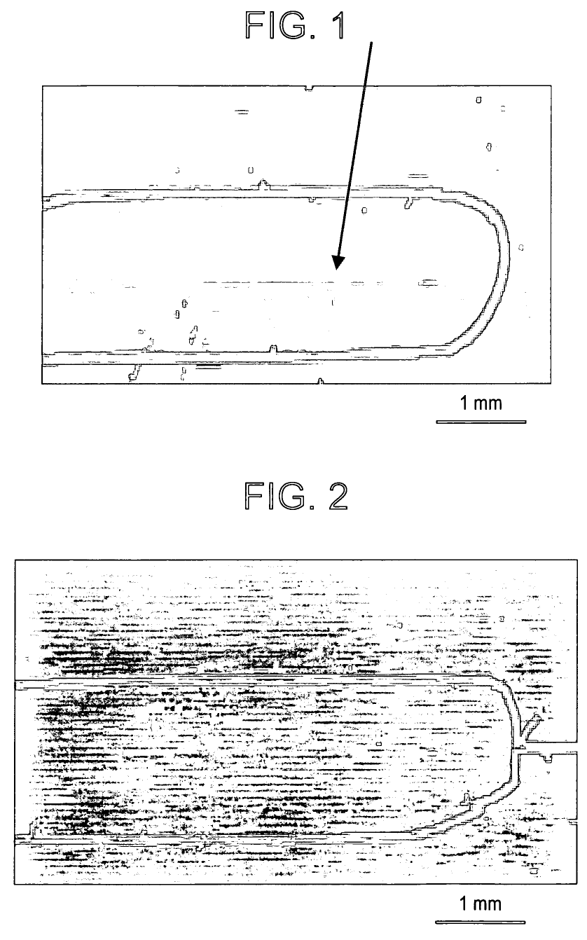

FIG. 2 shows the electroform after removal of the stain; there is no white line stain in the circle in FIG. 2 indicating that the defect was removed;

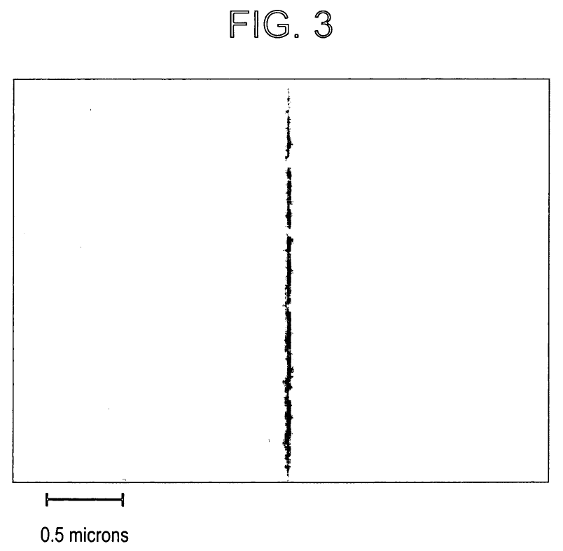

FIG. 3 shows a scanning electron microscope image of a 4th generation mold that exhibits no evidence of sub-micron pitting or roughening even after 20 full cycles of inspection, cleaning, and mold replication;

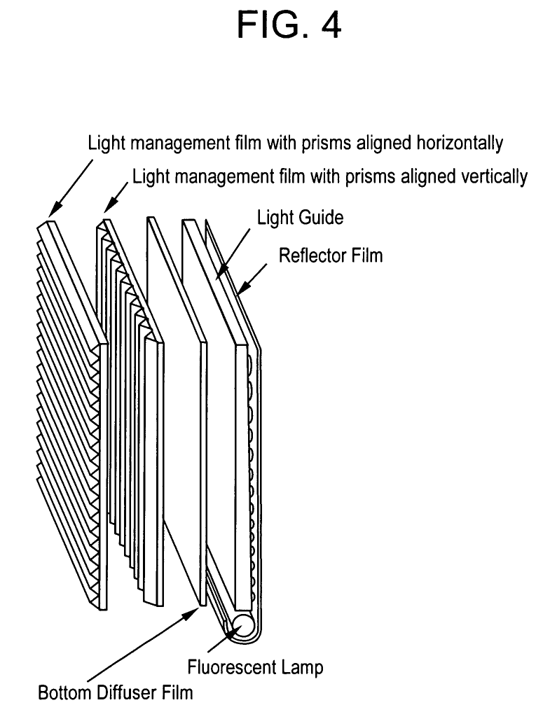

FIG. 4 is a schematic depicting how light management films are set-up in order to measure luminance; and

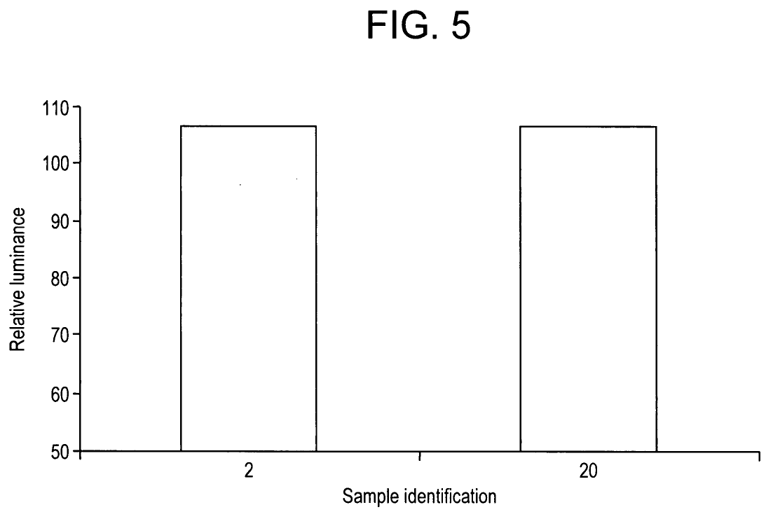

FIG. 5 is a bar graph showing the relative luminance of light management films made from a 4th generation, second copy mold and a 4th generation, 20th copy mold; the graph shows that there is no degradation in performance even after 18 full cycles of inspection, cleaning and mold replication.

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and independently combinable.

Disclosed herein are methods to eliminate defects from molds that are used in the manufacture of microstructured films. In one embodiment, the method comprises first inspecting the mold to detect any defects followed by cleaning the mold using a method designed to remove the defect. In another embodiment, all molds may be subjected to a single cleaning process or alternatively to a series of cleaning processes that can remove all defects without any inspection. The inspection process and the cleaning process can be performed manually or can be automated. In one embodiment, automated cleaning processes provide a number of advantages over manual methods. This includes the provision of efficient, reproducible processes, which can be more easily controlled and checked than manual methods.

The cleaning process effectively results in the removal of defects from the mold thereby leaving the mold capable of being used to produce successive generations of additional molds that can be used to produce light management films having an undamaged optical performance.

The cleaning processes are selected so as remove defects from the mold while at the same time not damaging the molds. In one embodiment, the cleaning processes are selected such that molds that are subjected to a plurality of cycles of the cleaning process do not undergo microscopic or macroscopic damage. In addition, the cleaning processes are selected such that the mold does not undergo a loss in luminance. A loss in luminance may be attributable to damage undergone during the cleaning process, which is undesirable.

The cleaning processes are selected such that a mold subjected to 1 or more cleaning cycles does not undergo a loss in cosmetic quality or optical properties. The term cosmetic quality implies that there are no scratches, pits, stains, or the like on the mold after being subjected to the cleaning process. The term optical properties include reflectance or luminance from the mold, when the mold is illuminated by a source of light.

In one embodiment, the cleaning processes are selected such that the molds can be subjected to 1 or more cleaning cycles without undergoing any degradation or loss in luminance. In another embodiment, the molds can be subjected to 5 or more cleaning cycles without undergoing any degradation or loss in luminance. In yet another embodiment, the molds can be subjected to 10 or more cleaning cycles without undergoing any degradation or loss in luminance. In yet another embodiment, the molds can be subjected to 20 or more cleaning cycles without undergoing any degradation or loss in luminance.

The molds can comprise metals, ceramics or polymers. The molds can be in the form of metal electroforms that are used for manufacturing microstructured films. The molds can be flat, curvilinear or cylindrical (e.g., drums). In one embodiment, the cleaning of the mold comprises processes such as soaking the mold in a cleaning solution, electrocleaning, ultrasonication, a high-pressure application of deionized (DI) water, or the like, or a combination comprising at least one of the foregoing processes.

The inspection process includes a visual inspection of the molds to observe defects and to optionally note their coordinates. A defect is a scratch, stain, pit, or the like, that can scatter visible light and that has at least one dimension that is greater than or equal to about 10 micrometers. This dimension can be measured along the surface of the mold or in a direction that is perpendicular to the surface of the mold. Thus a “cleaning process” that introduces at least one defect in a mold or a light management film that is made from the mold can be construed to have damaged the mold. When a child mold (made from a parent mold) has a defect that has at least one dimension of greater than or equal to about 10 micrometers that was transmitted by the parent mold, it is rejected thereby contributing to a decrease in yield. Similarly, when a light management film contains a defect that has at least one dimension of greater than or equal to about 10 micrometers that was transmitted from the mold, it is rejected thereby contributing to a decrease in yield. A cleaning process can also be construed to have damaged the mold if it changes the surface profile by roughening smooth surfaces of features or rounding sharp tips of features, even on a length scale of 10 nm. While this damage is invisible to the naked eye or most machine vision systems, it causes diffraction effects and scattering of light that degrades the optical quality of the mold and thus the optical performance of the films made from the mold.

Defects can be differentiated into two general types of defects, namely integral and removable defects. Integral defects are defects that are inherent in the mold. Such integral defects are caused during manufacturing or by physical damage that is present on the mold. Examples of these defects are scratches, dashes or separation marks.

Removable defects are superficial defects, which are formed by stains, dust, and other debris. Such defects are termed spiders, blue spots or whiskers. These defects are caused by the presence of removable debris on the mold. If these defects are not corrected before the parent mold is replicated into daughter molds, all daughter molds will have an integral defect, which is the geometric replication of the original defect. The inspection system is able to distinguish between integral and removable defects and this allows for the eradication of removable defects from the mold or alternatively, the elimination of those molds that have integral defects. In either event, the initial defect will not be propagated to future generations.

The visual inspection can be conducted in a batch process, in a continuous process, or in a semi-continuous batch process. A batch process is one where each mold is examined manually or where the inspection process is manually assisted (e.g., the molds are placed in the sample holder manually). A continuous process is one that is automated such that the molds are mounted on a conveyor belt that moves the molds into the field of view of the inspection system. A semi-continuous batch process comprises a manual or manually-assisted inspection or an automated inspection. Both, the visual inspection and the defect detection may also be automated.

The inspection process can include, for example, a manual inspection, a camera-assisted inspection, or an automated camera inspection. For example, the manual inspection process can comprise an unaided visual inspection. In another embodiment, the inspection process can comprise using visual aids such as line-scan cameras, area cameras, or the like. In still another embodiment, the inspection process comprises using microscopes including light and electron microscopic inspection. For example, the light microscopic inspection comprises using objective lenses of about 5× magnification to about 1000× magnification. In another example, the electron microscopic inspection comprises using scanning electron microscopy (SEM). In yet another embodiment, the inspection can comprise using SEM and energy dispersive x-ray analysis (EDX).

During the inspection process, the mold is illuminated by a light source or by a combination of light sources. The light sources are generally arranged to promote contrast between the defect and the mold, which facilitates detection and identification of the defect. The light sources can include using a flashlight to examine a mold for defects or can include using a commercially available light source that utilizes up to about ten million candelas for illuminating the mold. In another embodiment, a light source that utilizes greater than about ten million candelas can be used. In another embodiment, the light sources can include structured lights, transition lighting, collimated light sources, and/or diffuse light sources. In another embodiment, the light source can use magnifying light to illuminate and examine the mold. The light source can be arranged such that all types of defects are illuminated.

In one embodiment comprising a camera-assisted inspection, a camera is mounted perpendicular to the mold to be inspected. The camera can record an image of the illuminated mold. The image can be displayed, for example, on a computer screen. In one embodiment, an operator inspects a magnified, illuminated image displayed on a computer screen and determines whether a defect is present. In another embodiment comprising an automated camera inspection, the image is transferred from the camera to a computer that can analyze the magnified, illuminated image of the mold to determine the presence of a defect.

There are several types of removable defects. One example of a removable defect comprises a particle disposed upon a surface of a mold. These types of particles include a fiber, a metal chip or a flake, dust, or the like and are generally embedded in the microstructure, for example, in the grooves between prisms. Other types of removable defects (“whiskers” or “spiders”) can further emanate from a particle disposed upon a surface of a mold, where, for example, long arms project out from under the particle. The arms are caused by liquid trapped under the solid particle that eventually propagates down a groove on the mold surface due to capillary action. The liquid upon being dried leaves behind a residue of debris and salts that scatter light. “Whiskers” are another set of defects and comprise a particle disposed upon a single surface groove. The trapped liquid propagates out from the particle along the single groove forming one or two arms. “Spiders,” on the other hand, comprise a particle disposed across several surface grooves and hence have a plurality of arms. Another example of a removable defect is a stain, which generally comprises a dried liquid residue. A stain can further comprise salts. Such defects are in general caused by contamination from the air, contaminants in the electroforming baths, contaminants such as greases and oils, inadequate rinsing and cleaning procedures, or the like.

After the inspection process, the mold can be subjected to a cleaning process to remove defects. To effectively and efficiently eliminate different types of removable defects, a suitable cleaning process is matched to a particular type of removable defect. The inspection process can determine what type of removable defect is present. Because a cleaning process is tailored for a specific type of defect, the removable defect can be completely removed without wasting a large amount of time and materials. Exemplary cleaning processes can comprise soaking, electrocleaning, ultrasonication, a high-pressure application of deionized (DI) water, or the like, or a combination comprising at least one of the foregoing cleaning processes.

A suitable cleaning process can use an effective cleaning solution for removing a particular type of defect. In one embodiment, a suitable cleaning solution is water. When water is to be used for removing a defect, it is generally desirable to use deionized (DI) water. DI water is generally used for removing defects that are soluble in water or other polar solvents.

In another embodiment, solvents other than water can be used for soaking the mold to remove defects. Solvents can be polar or non-polar. In one embodiment, non-hazardous solvents with low vapor pressure are desirable. Exemplary polar solvents include ketones (e.g., acetone, methyl ethyl ketone, or the like), alcohols (e.g., methyl alcohol, ethyl alcohol, isopropanol, or the like), propylene carbonate, ethylene carbonate, butyrolactone, acetonitrile, benzonitrile, nitromethane, nitrobenzene, sulfolane, dimethylformamide, N-methylpyrrolidone, or the like, or a combination comprising at least one of the foregoing solvents. Exemplary non-polar solvents include benzene, toluene, methylene chloride, carbon tetrachloride, hexane, diethyl ether, tetrahydrofuran, or the like, or combinations comprising at least one of the foregoing solvents may also be used. Co-solvents comprising at least one polar solvent and at least one non-polar solvent may also be utilized.

In another embodiment, cleaning solutions comprising commercially available general purpose cleaners, such as those used for residential and industrial purposes may be used for cleaning. These commercially available cleaners can be further diluted with water or other solvents as desired and used for soaking the mold. In another embodiment, cleaning solutions designed to clean metals, such as nickel or nickel alloy molds, can be used. The chemical composition of the cleaning solution can vary according to the particular defect to be removed. Suitable cleaning solutions can comprise various cleaning agents including ionic (e.g., anionic, cationic, and zwitterionic) and nonionic detergents, as well enzymatic cleaning agents. A suitable cleaning solution can further comprise a non-foaming agent. Suitable cleaning solutions can comprise an alkaline, acidic or a buffered pH solution according to a particular application of the cleaning solution. In other embodiments, suitable cleaning solutions can comprise a solvent. Examples of suitable commercially available cleaning solutions include SIMPLE GREEN®, MICRO-90®, ZYMIT®, LF2100®, SURFACE CLEANSE/930®, STAMPERPREP®, DISCLEAN®, as well as various Alconox products including LIQUINOX® and CITRANOX®. A suitable cleaning solution can be selected according to the mold, removable defect present, as well as the future application of the mold. For example, STAMPERPREP® is a high alkalinity, low foaming, detergent rich cleaning agent that can be used to clean a nickel or nickel alloy mold used in the manufacture of optical media.

The cleaning solution may be added to water or to the organic solvent in an amount of about 2 to about 100 wt %, based on the total weight of the solution. In another embodiment, the cleaning solution may be added to water or to the organic solvent in an amount of about 5 to about 75 wt %, based on the total weight of the solution. In yet another embodiment, the cleaning solution may be added to water or to the organic solvent in an amount of about 10 to about 60 wt %, based on the total weight of the solution.

In one embodiment, the cleaning process comprises soaking a mold in an appropriate cleaning solution for about 2 minutes to about 2 hours at a desired temperature. In one embodiment, the cleaning process comprises soaking the mold in an appropriate cleaning solution for about 15 minutes to about 90 minutes. In yet another embodiment, the cleaning process comprises soaking the mold in an appropriate cleaning solution for about 30 minutes to about 60 minutes.

The temperature of the soaking solution can vary according to the particular defect and particular mold. In one embodiment, the mold can be soaked in a cleaning solution maintained at a temperature of about 25° C. to about 95° C. In another embodiment, the mold can be soaked in a cleaning solution maintained at a temperature of about 35° C. to about 85° C. In yet another embodiment, the mold can be soaked in a cleaning solution maintained at a temperature of about 45° C. to about 75° C. In addition, the cleaning process can comprise a cleaning soak step in combination with other cleaning processes such as mechanical agitation, ultrasonic agitation, or the like.

In one embodiment, in one method of using a cleaning solution to remove defects from the mold, SIMPLE GREEN®, a commercially available cleaning solution that comprises a combination of organic solvents is added to water and used to soak the mold. The SIMPLE GREEN® is added to water in an amount of about 1 wt % to about 25 wt %, based on the total weight of the solution. In another embodiment, the SIMPLE GREEN® is added to water in an amount of about 3 wt % to about 12 wt %, based on the total weight of the solution. In yet another embodiment, the SIMPLE GREEN® is added to water in an amount of about 5 wt % to about 10 wt %, based on the total weight of the solution. The solution is maintained at room temperature during the soaking. The time period for soaking is about one minute to about thirty minutes. In one embodiment, the time period for soaking is about three minutes to about fifteen minutes. In another embodiment, the time period for soaking is about five minutes to about ten minutes. This solution can be used to remove a variety of defects including dust, metal particles, dirt, or the like. In addition, this solution can be used to remove defects caused by oils, greases, salt deposits, or the like.

In another embodiment, in another method of using a cleaning solution to remove defects from the mold, MICRO-90®, a commercially available cleaning solution that comprises a mixed buffered solution is added to water and used to soak the mold. The MICRO-90® is added to water in an amount of 2 wt %, based on the total weight of the solution. The solution is maintained at room temperature during the soaking. The time period for soaking is about one minute to about four hours. In one embodiment, the time period for soaking is about fifteen minutes to about three hours. In another embodiment, the time period for soaking is about thirty minutes to about two hours. This solution can be used to remove a variety of defects including stains, whiskers, spiders, or the like. In addition, this solution can be used to remove types of defects including oils, greases, salt deposits, organic contaminates such as starches and protein-based soils, or the like.

In another embodiment related to soaking, a solution comprising CITRANOX® and water can be used for removing defects. The solution comprising CITRANOX® and water can also be used for neutralizing the surface of the mold after electrocleaning. For example, the solution comprises about 0.5 wt % to about 10 wt % CITRANOX®. In another embodiment, the cleaning process comprises using a plurality of rinses, wherein the plurality of rinses can further comprises varying concentrations of a cleaning solution. For example, the cleaning process comprises using a first rinse comprising a cleaning solution having a concentration of about 5% to about 10% of CITRANOX® and a second rinse comprising a cleaning solution having a concentration of about 1% to about 5% of CITRANOX®. In another embodiment, the cleaning process comprises using a rinse comprising DI water without a cleaning solution. The cleaning process can comprise using a rinse at about 22° C. to about 50° C., more specifically about 25° C. to about to 30° C. The cleaning process can comprise using a plurality of rinses wherein each rinse is at the same temperature. In another embodiment, the plurality of rinses comprises using rinses at different temperatures.

As noted above, the cleaning processes can also include electrocleaning (i.e., electrolytic cleaning). Electrocleaning is the process by which a workpiece is made the anode or the cathode in a bath comprising the cleaning solution. An exemplary cleaning solution is an alkaline cleaning solution. A direct current of about 3 to about 12 volts is applied to yield a current density of about 10 to about 150 amp/ft² (about 1 to about 15 amp/dm²) of work area. Electrocleaning can be employed alone or can be preceded by a cleaning soak or some other form of precleaning. In one embodiment, the electrocleaning process is conducted in substantially the same chemical environment as the soak cleaner. In an alternative embodiment, the electrocleaning process is conducted in a different chemical environment as the preceding soak cleaner. For example, an acidic soak can precede an alkaline electrocleaning process to aid in neutralizing the pH of the acidic soak.

Anodic electrocleaning can be used on metals, such as ferrous metals. In this process, the workpiece is the anode (positive), free electrons are discharged by the hydroxyl ions to the metal, resulting in a liberation of gaseous oxygen. The oxygen generated at the work surface provides continuous dynamic agitation, removing and loosening debris thereby greatly aiding the removal of defects. The process also activates the metal surface for subsequent removal of other defects by acid pickling.

Cathodic electrocleaning makes use of a negative charge on the workpiece. In this process, hydrogen gas is released at the cathode at twice the volume of oxygen at the anode resulting in scrubbing action and solution agitation. In addition, the negatively charged workpiece repels negatively charged defects.

Periodic reverse (PR) cleaning can also be employed to combine the effects of anodic and cathodic electrocleaning. Periodic reverse cleaning is a cyclical form of cleaning where the mold to be cleaned is alternatively made the anode or the cathode at intervals of about 4 to about 10 seconds. This produces hydrogen and oxygen alternatively at the work surface and can be highly effective at removing particular defects. In one embodiment, the final cycle is made anodic to remove any deposits formed during the cathodic cycle.

In one embodiment, in one manner of eliminating defects from the mold, a cleaning solution comprising STAMPERPREP® can be used in an electrolytic bath to clean the mold. The mold is used as the cathode. A current of about 4 to about 5 amperes per square foot was applied between the electrodes of the electrolytic bath to clean the mold.

In one embodiment, the cleaning solution comprises STAMPERPREP® in an amount of about 1 wt % to about 5 wt %, based on the total weight of the cleaning solution. In one embodiment, the cleaning solution comprises STAMPERPREP® in an amount of about 2 wt % to about 4 wt %, based on the total weight of the cleaning solution. In one embodiment, when STAMPERPREP® is used in a electrolytic bath, the bath temperature was maintained at about 25° C. to about 50° C. In another embodiment, the bath temperature was maintained at about 30° C. to about 40° C. In another embodiment, the bath temperature was maintained at about 33° C. to about 38° C. In another embodiment, the cleaning process comprises using a current of about four to about five amperes per square foot for about 1 to about 10 minutes. The cleaning process using the STAMPERPREP® in an electrolytic bath can be conducted for about 2 minutes to about 8 minutes.

After electrocleaning, the mold can optionally be subjected to soaking to neutralize any acids or bases left over on the surface of the mold from the electrocleaning process. An exemplary formulation for an alkaline soak cleaning solution is shown in Table 1. The weight percents shown in the Table 1 are based on the total weight of the cleaning solution. Specific formulations and conditions shown in the Table 1 can be tailored for each application. The formulation of the cleaning solution and the bath temperature will vary according to the particular defect to be removed as well as the mold to be cleaned.

TABLE 1

| Component | Weight percent (wt %) |
|---|---|
| Sodium metasilicate | about 20 to about 60 |
| Sodium tripolyphosphate | about 6 to about 12 |
| Sodium carbonate | about 15 to about 35 |
| Sodium hydroxide | about 10 to about 20 |
| Surfactant(s) | about 1 to about 6 |
| Chelating agents | about 1 to about 5 |

In yet another embodiment, the mold can optionally be subjected to a stream of high pressure DI water in order to remove acidic or basic traces after the electrocleaning process.

In still another embodiment, the cleaning process comprises an application of high-pressured DI water. In one embodiment, a suitable high-pressure DI water apparatus comprises a single jet delivering approximately 1200 pulses per minute at a pressure of about 15 pounds per square inch (psi) to about 75 psi. In another embodiment, a suitable high-pressure DI water apparatus comprises a plurality of pulsating jets, for example, about 12 to about 14 jets, operatively connected to a diaphragm pump comprising an input air pressure of, for example, about 85 psi or greater and an output pressure of about 45 psi to about 55 psi. The mold can be blasted with the water jets for an amount of time effective to clean the molds without damaging the mold or reducing the amount of light reflected from the surface of the mold.

A cleaning process that comprises applying high-pressure DI water is suitable to remove defects such as embedded particles including, for example dust, metal particles, dirt, fibers, or the like. These embedded particle defects can also manifest themselves in the form of whiskers, spots, and spiders. In another embodiment, a cleaning process comprising applying high-pressure DI water is suitable to remove and/or prevent types of defects that are soluble in water, such as water soluble stains.

In one embodiment, the pressure used in the jets can vary in an amount of about 1 psi to about 75 psi. In another embodiment, the pressure used in the jets can vary in an amount of about 10 psi to about 50 psi. In yet another embodiment, the pressure used in the jets can vary in an amount of about 20 psi to about 40 psi.

In another embodiment, the cleaning process comprises ultrasonication. High-intensity ultrasonication that uses a frequency of greater than or equal to about 16 kilohertz (kHz) is based on the interaction of the high frequency sound waves with the removable defects on the surface of the mold. The defect is removed because of mechanical, thermal and sonochemical effects attributed to generation and collapse of cavitational bubbles. A cleaning process comprising ultrasonication is suitable to remove defects such as stains, oils, embedded particles, whiskers, spiders, or the like.

In one embodiment, in one manner of cleaning the mold using ultrasonication, water or an organic solvent may be used as the media in which the mold is immersed during ultrasonication. In one embodiment, the mold is immersed in a medium comprising organic mineral spirits (OMS). Commercially available cleaning solutions may be added to the water or to the organic solvents during ultrasonication. The cleaning solution may be added to water or to the organic solvent in an amount of about 2 to about 90 wt %, based on the total weight of the solution. In another embodiment, the cleaning solution may be added to water or to the organic solvent in an amount of about 5 to about 75 wt %, based on the total weight of the solution. In yet another embodiment, the cleaning solution may be added to water or to the organic solvent in an amount of about 10 to about 60 wt %, based on the total weight of the solution. Ultrasonication can be conducted for a time period of about 1 minute to about 1 hour if desired. In another embodiment, ultrasonication can be conducted for a time period of about 2 minutes to about 30 minutes if desired.

After treatment of the mold with the appropriate cleaning method, the mold can be re-inspected to ensure the removal of the previously identified defect and to further ensure that no new defects have been introduced. In the case of a newly discovered defect, the method can be repeated, i.e., identifying the defect and treating with the appropriate cleaning method.

In one embodiment, in one manner of proceeding, a method for removing defects comprises inspecting the molds, sorting the molds based upon the type of the defect, subjecting the mold to the appropriate cleaning process, and re-inspecting the mold for defects prior to using the mold for production of light management films or prism sheets.

In another embodiment, in another method of proceeding, a method for removing defects comprises inspecting the molds, sorting the molds based upon the type of the defect, subjecting the mold to a series of cleaning process to remove multiple types of defects, and re-inspecting the mold for defects prior to using the mold for production of light management films or prism sheets.

In yet another embodiment, in another method of proceeding, a method for removing defects comprises excluding the inspecting of the molds. This step comprises subjecting all molds to a series of cleaning processes to remove multiple types of defects and then using the mold for production of light management films or prism sheets. Inspection is thus avoided.

In another embodiment, the cleaning process comprises rinsing and drying. A cleaning process comprising rinsing and drying is suitable to remove defects such as residual salts on the mold remaining from the electroforming bath. In the absence of rinsing and drying, the residual salts can potentially re-concentrate on the surface of the mold resulting in stains.

After the mold is subjected to the inspection process and/or the cleaning process, it can be used to press a generation of light management films or alternatively it can be used as a template to manufacture a generation of molds. The methods described above are therefore advantageous in that defects are not transferred from one generation of molds to the next. Cleaning the molds also permits defect free light management films to be manufactured thereby improving the yields of the manufacturing process.

The following examples, which are meant to be exemplary, not limiting, illustrate compositions and methods of cleaning some of the molds described herein.

### EXAMPLES

### Example 1

This example demonstrates a series of cleaning processes that can be used for eliminating defects from a metal electroform without a reduction in optical quality of the mold. As will be seen below, the cleaning process comprises subjecting the electroform to a series of process that facilitate removal of the defects from the surface of the electroform. After each cleaning step, the electroform is subjected to a rinse in DI water to remove any traces of acid or base. Following each rinse, the electroform is once again subjected to inspection to determine if all defects are eliminated. When all of the defects are eliminated, the cleaning process is stopped.

In this example, a manufactured electroform is first subjected to an initial cleaning. The electroform was peeled from a master and subjected to an initial cleaning comprising a DI water rinse.

The electroform is then subjected to a one-minute DI water rinse using a high-pressure jet under ambient temperature. The electroform is then dried and inspected for defects. If a defect is found to be present, electrocleaning is performed at 10.5 volts with about 4 to 5 amps per square foot using STAMPERPREP® cleaning solution for about five minutes. Following the electrocleaning, the electroform is rinsed in DI water. The electroform is then soaked in a 2% Citranox solution for 3 minutes followed by another rinse in DI water. The electroform is then dried and re-inspected. If defects are still found to be present, the electroform is soaked in 1% MICRO-90® solution for 30 minutes following which it was inspected again. If the defect is still present, then the electroform is soaked in the MICRO-90® solution for up to 2 hours.

### Example 2

This example was conducted to demonstrate the removal of a defect from an electroform when using ultrasonication as part of a cleaning process. FIG. 1 and FIG. 2 depict photographs showing the defect before and after the cleaning process respectively. FIG. 1, which represents a photograph of the defect, shows a horizontal white line stain in the middle of the circle. The circle indicates the location of the defect. The electroform was then subjected to ultrasonication to remove the defect.

A 5 wt % solution of MICRO-90® in water (based on the total weight of the solution) was used as the media for ultrasonication. Ultrasonication was conducted for a period of 5 minutes at room temperature. Following ultrasonication, the defect was removed. FIG. 2 shows the electroform after removal of the stain. There is no white line stain in the circle in FIG. 2 indicating that the defect was removed.

### Example 3

This example was performed to demonstrate the lack of damage to molds subjected to the selected cleaning processes. A third-generation mold was used to produce 20 children, undergoing the inspection, cleaning and replication process each time. To clean the electroforms for use as a parent for manufacturing a series of future generations of molds, or for use as a template to make light management films, the molds were subjected to a series of steps as detailed in Example 1. After each cleaning step, the mold was subjected to inspection. Inspections were conducted visually using a flashlight or a camera. Automated inspections were also performed on the mold after some of the cleaning steps.

The 20^{th} child of this third generation mold, itself a fourth generation mold, was then examined using scanning electron microscopy. An image of the mold is shown in the FIG. 3. After going through 20 full cycles of inspection, cleaning and replication, the third generation parent had not propagated any sub-micron roughness or pitting onto its 20^{th} child, indicating that these cleaning processes can clean the mold while at the same time preserving it for long term use.

### Example 4

This example demonstrates the performance of two batches of light management films manufactured from sibling fourth-generation molds. One batch of light management films was made from a mold that was the second child to come off its third generation parent. The other batch was made from a mold that was the 20^{th} child to come off the same third generation parent. The example shows that light management films display almost identical relative luminance characteristics despite the fact that the parent third generation mold was subjected to 18 cycles of cleaning, replication and inspection between the production of the second child mold and the 20^{th} child mold.

The luminance of the two light management films was tested as follows. A bottom diffuser is placed in a backlight with an inverter. The bottom diffuser is a D120® commercially available from Tsujiden Co. Ltd, while the backlight is a LG Philips LP121X1® backlight having a single cold cathode fluorescent light (CCFL) as the source of illumination. The inverter is a LS390® inverter commercially available from Taiyo Yuden. A light management film in the vertical configuration is placed over the bottom diffuser. A light management film in the horizontal configuration is placed over the vertical light management film. In order to make the luminance measurement on a particular light management film, the light management film was cut into 2 portions. One portion was used in the vertical configuration and the other portion was used in the horizontal configuration. The configurations are shown in the FIG. 4.

Several thermocouples monitor the temperature of the backlight. After each set of samples is installed in the activated backlight, the system is allowed to equilibrate until the backlight temperature remains steady to within 0.1 degrees over the course of 5 minutes. After the system is equilibrated, a SS220® Display Analysis System commercially available from Microvision is used to measure 13 point luminance uniformity and the view angle at the center point. Performance is measured in “relative luminance” units compared to a brightness enhancing film (BEF2) film manufactured by 3M.

The data for both copies of light management films is shown in the FIG. 5. From this figure it can be seen that both films have a relative luminance of about 106 units. The films from the 2^{nd} copy had an average normalized luminance of 106.72% with a standard deviation of 0.15%, while the films from the 20ₜₕ copy had an average normalized luminance of 106.76% with a standard deviation of 0.16%, which makes them statistically equal at a 95% confidence limit. In other words, even after 18 inspection, cleaning, and replication cycles, there was no decrease in quality of the film produced from the molds.

From the above examples, it may be seen that several cleaning processes can be used sequentially to remove defects. Alternatively a single cleaning process can be used to remove defects and increase yield. The example shows that light management films display almost identical relative luminance characteristics despite the fact that the parent third generation mold was subjected to 18 cycles of cleaning, replication and inspection between the production of the second child mold and the 20^{th} child mold.

In an advantageous embodiment, a parent mold that has been subjected to the inspection and/or cleaning process can be used as a template to create a first generation of daughter molds. A mold from the first generation of daughter molds can be used to create a second generation of daughter molds. In one embodiment, several molds from the first generation of daughter molds can be used to create a plurality of second generations of daughter molds. In this manner a tooling tree that comprises a plurality of generations of molds that is defect free can be created.

In one embodiment, by using a manufacturing method that comprises the aforementioned inspection and/or cleaning processes, the yield of molds in a given tooling tree of manufactured molds can be improved by about 10 to about 90% over the yields from those manufacturing methods that do not involve inspection and/or cleaning processes. In other words, if a mold from a first generation of daughter molds is subjected to the inspection and/or cleaning process and is used as a template to manufacture additional molds for a second generation of daughter molds, then the yield of second generation daughter molds can be increased in an amount of about 10 to about 90% over another comparative second generation of daughter molds manufactured from a comparative first generation daughter mold that has not been subjected to the cleaning process.

In another embodiment, the yield of molds in a given tooling tree can be improved by about 30 to about 85% over the yield obtained from other comparative manufacturing methods that do not involve inspection and/or cleaning processes. In yet another embodiment, the yield of molds in a given tooling tree can be improved by about 40 to about 80% over the yield obtained from other comparative manufacturing methods that do not involve inspection and/or cleaning processes. In yet another embodiment, the yield of molds in a given tooling tree can be improved by about 45 to about 75% over the yield obtained from other comparative manufacturing methods that do not involve inspection and/or cleaning processes.

Similarly, the yield of light management films or prism sheets can be improved by about 20 to about 90% over the yield from a comparative method that does not involve inspection and/or cleaning processes for the molds. In one embodiment, the yield of light management films or prism sheets can be improved by about 25 to about 75% over the yield from a comparative method that does not involve inspection and/or cleaning processes for the molds. In one embodiment, the yield of light management films or prism sheets can be improved by about 30 to about 50% over the yield from a comparative method that does not involve inspection and/or cleaning processes for the molds.

In one embodiment, a mold that is subjected to the cleaning process can undergo a reduction in the number of defects present in the mold. The reduction in the number of defects can be at least about 1% over a comparative mold that is not subjected to the cleaning process. In one embodiment, the reduction in the number of defects can be at least about 2% over a comparative mold that is not subjected to the cleaning process. The reduction in the number of defects can be at least about 5% over a comparative mold that is not subjected to the cleaning process. In one embodiment, the reduction in the number of defects can be at least about 10% over a comparative mold that is not subjected to the cleaning process. In another embodiment, the reduction in the number of defects can be at least about 50% over a comparative mold that is not subjected to the cleaning process. In yet another embodiment, the reduction in the number of defects can be at least about 100% over a comparative mold that is not subjected to the cleaning process.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method comprising:
inspecting a mold for a defect;
determining a type of defect present on the mold;
sorting the mold by type of defect present;
treating the mold with a cleaning process that is suitable to remove the defect; and
pressing the mold against a polymeric film to produce a series of light management films; wherein the yield of defect free light management films manufactured from the mold is higher than the yield of light management films that are produced from a comparative mold that has not been treated with the cleaning process.

2. The method of claim 1, wherein the inspecting is conducted under light sources that increase contrast between the defects and the mold.

3. The method of claim 1, further comprising inspecting the mold after the cleaning to determine if the defect is removed.

4. The method of claim 1, wherein the inspecting the mold comprises using a camera to inspect the mold.

5. The method of claim 4, wherein the camera is a line-scan camera or an area camera.

6. The method of claim 1, wherein the inspecting the mold comprises using a scanning electron microscope and/or energy dispersive xray analysis to inspect the mold.

7. The method of claim 1, wherein the cleaning process comprises soaking the mold in deionized water.

8. The method of claim 1, wherein the cleaning process comprises soaking the mold in an organic solvent.

9. The method of claim 1, wherein the cleaning process comprises subjecting the mold to ultrasonication.

10. The method of claim 9, wherein the ultrasonication is conducted in water, in organic solvents, or in a combination comprising water and organic solvents.

11. The method of claim 1, wherein the cleaning process comprises subjecting the mold to electrocleaning.

12. The method of claim 11, wherein the electrocleaning is conducted in water, in organic solvents, or in a combination comprising water and organic solvents.

13. The method of claim 1, wherein the cleaning process comprises subjecting the mold to a water jet pressurized to at least 15 pounds per square inch.

14. The method of claim 1, wherein the cleaning process comprises subjecting the mold to soaking, electrocleaning, a water jet pressurized to at least 15 pounds per square inch, ultrasonication, or a combination comprising at least one of the foregoing cleaning processes.

15. The method of claim 7, further comprising adding a cleaning agent to the deionized water.

16. The method of claim 15, wherein the cleaning agent comprises an ionic cleaning agent, a non-ionic cleaning agent, an enzymatic cleaning agent, or a combination comprising at least one of the cleaning agents.

17. The method of claim 15, wherein the cleaning agent further comprises a non-foaming agent, an alkaline pH solution, an acidic pH solution, a buffered pH solution, or a combination comprising at least one of the foregoing.

18. The method of claim 1, wherein the mold is an electroform.

19. The method of claim 1, wherein the mold that is subjected to the cleaning process has a reduction in defects in an amount of about 1 to about 100% over a comparative mold that has not been subjected to the cleaning process.

20. The method of claim 1, further comprising using the mold after being treated with the cleaning process as a template to produce a first generation of molds.

21. The method of claim 1, further comprising using the mold to produce a tooling tree, wherein the tooling tree comprises a plurality of generations of molds.

22. The method of claim 1, wherein the yield of molds for the tooling tree is about 10 to about 90% greater than a comparative tooling tree manufactured by a process that does not comprise an inspection and/or cleaning processes.

23. A method comprising:
treating a mold with a cleaning process to form a clean mold; wherein the cleaning process comprises subjecting the electroform to soaking, electrocleaning, a water jet pressurized to at least 15 pounds per square inch, ultrasonication, or a combination comprising at least one of the foregoing cleaning processes; and
electroforming a mold using the clean mold as a template.

24. The method of claim 23, further comprising inspecting the mold under visible light.

25. The method of claim 23, wherein the mold is an electroform.

26. The method of claim 23, wherein the mold that is treated to the cleaning process has a reduction in defects in an amount of about 1 to about 100% over a comparative mold that has not been subjected to the cleaning process.

27. A method comprising:
inspecting a mold for a defect;
determining a type of defect present on the mold;
sorting the mold by type of defect present; and
treating the mold with a cleaning process that is suitable to remove the defect without damaging the mold.

28. The method of claim 27, wherein the cleaning process comprises soaking the mold in a solvent, electrocleaning the mold, blasting the mold with a water jet pressurized to at least 15 pounds per square inch, ultrasonication, or soaking the mold in an ionic cleaning agent, a non-ionic cleaning agent, an enzymatic cleaning agent or a combination comprising at least one of the cleaning agents.

29. A method comprising:
inspecting a mold for a defect;
determining a type of defect present on the mold; and
treating the mold with a cleaning process comprising one or more cycles that is suitable to remove the defect; wherein the mold does not undergo a degradation in cosmetic quality or luminance as a result of being subjected to the cleaning process.

30. The method of claim 29, wherein the cleaning process comprises 5 or more cycles.

31. The method of claim 29, wherein the cleaning process comprises 10 or more cycles.

32. The method of claim 29, wherein the inspecting is conducted under light sources that increase contrast between the defects and the mold.

33. The method of claim 29, further comprising inspecting the mold after the cleaning to determine if the defect is removed.

34. The method of claim 29, wherein the inspecting the mold comprises using a camera to inspect the mold.

35. The method of claim 29, wherein the cleaning process comprises soaking the mold in deionized water.

36. The method of claim 29, wherein the cleaning process comprises soaking the mold in an organic solvent.

37. The method of claim 29, wherein the cleaning process comprises subjecting the mold to ultrasonication.

38. The method of claim 29, wherein the cleaning process comprises subjecting the mold to electrocleaning.

39. The method of claim 29, wherein the cleaning process comprises subjecting the mold to soaking, electrocleaning, a water jet pressurized to at least 15 pounds per square inch, ultrasonication, or a combination comprising at least one of the foregoing cleaning processes.

40. The method of claim 29, wherein the mold is an electroform.

41. A film manufactured by the method of claim 1.

42. A mold manufactured by the method of claim 23.
